(19) United States
(12) Patent Application Publication
(10) Pub. No.: US 2006/0133544 A1
(43) Pub. Date: Jun. 22, 2006

(54) Diversity receiver and diversity reception method

(75) Inventors: Tomoharu Kawada, Osaka (JP); Tomohiro Kimura, Osaka (JP)

Correspondence Address: PANASONIC PATENT CENTER;c/o MCDERMOTT WILL & EMERY LLP, 600 13TH STREET, NW, WASHINGTON, DC, 20005-3096, US

(73) Assignee: MATSUSHITA ELECTRIC INDUSTRIAL CO., LTD.

(21) Appl. No.: 11/262,822

(22) Filed: Nov. 1, 2005

(30) Foreign Application Priority Data
Dec. 16, 2004 (JP) 2004-364360

(51) Int. Cl. H04L 27/06; H04L 27/08; H04L 1/02

(52) U.S. Cl. 375/343; 375/347; 375/345

(57) ABSTRACT

A diversity receiver comprises: a control section for generating an antenna selection signal such that a plurality of antennas are sequentially selected on a one-by-one basis; a plurality of correlation sections which correspond to the plurality of antennas on a one-to-one basis, each of the correlation sections determining a correlation value between a signal received through a corresponding antenna and a predetermined pattern; and a correlation detector for detecting the predetermined pattern in a signal received through each of the plurality of antennas based on a correlation value determined by a corresponding one of the correlation sections and an average power corresponding to the antenna and outputting a detection result. The control section determines an antenna through which a signal including the predetermined pattern detected by the correlation detector is received as the antenna that is to be subsequently selected based on the detection result of the correlation detector.

### CROSS-REFERENCE TO RELATED APPLICATION

This application claims priority under 35 U.S.C. §119(a) on Japanese Patent Application No. 2004-364360 filed on Dec. 16, 2004, the entire contents of which are hereby incorporated by reference.

### BACKGROUND OF THE INVENTION

1. Field of the Invention

The present invention relates to a diversity receiver and a diversity reception method. Specifically, the present invention relates to a receiver and method for diversity reception wherein an antenna which is to be used for reception is selected among a plurality of antennas.

2. Description of the Prior Art

In mobile communication, such as wireless LAN (Local Area Network), or the like, the reception performance has been known to significantly deteriorate due to a fading phenomenon, i.e., a tremendous variation in received field intensity which is caused by reflected and/or scattered waves. A wave receiving technique that reduces such an effect of fading is diversity reception wherein a signal to be demodulated is selected among signals derived from a plurality of reception routes. One of the known diversity reception techniques is antenna diversity reception wherein an antenna which is to be used for reception is selected among a plurality of antennas.

FIG. 17 is a block diagram of a conventional antenna diversity receiver. This receiver is disclosed in, for example, Japanese Laid-Open Patent Publication No. 9-148973. In FIG. 17, an antenna switching section 922 selects any of signals received through two antennas 11 and 12. An AGC (Automatic Gain Control) circuit 924 and a control voltage generator (e.g., VCO) 934 make the reception input level constant. A control section 932 determines which antenna provides the greater received power based on the control voltage output from the control voltage generator 934. According to the determination result, the control section 932 outputs an antenna selection signal to the antenna switching section 922 such that an antenna of the greater received power is selected.

However, in the receiver as shown in FIG. 17, the received power cannot be precisely determined without convergence of a feedback loop formed by the AGC circuit 924 and the control voltage generator 934, and accordingly, comparison of power consumes time. For example, when there is a large difference between the received powers of the two antennas, the power input to the AGC circuit 924 abruptly changes at the time of switching the antennas, and therefore, more time is consumed until convergence of the feedback loop.

In high speed wireless packet communication, such as wireless LAN, or the like, a plurality of terminals transmit wireless packets at an arbitrary time. On the receiver side, selection of an antenna, automatic gain control (AGC), and detection of packets have to be carried out within a preamble period of several microseconds. Thus, these processes cannot be performed in the conventional structure.

### SUMMARY OF THE INVENTION

An objective of the present invention is to provide a diversity receiver which selects an optimum antenna within a short period of time.

Specifically, according to an aspect of the present invention, there is provided a diversity receiver, comprising: a control section for generating an antenna selection signal such that a plurality of antennas are sequentially selected on a one-by-one basis; a gain amplifier for amplifying, based on a gain control signal, a signal which is received through an antenna selected according to the antenna selection signal; a power measurement section for measuring a power of the signal amplified by the gain amplifier; an averaging section for calculating an average power of each of signals received through the plurality of antennas based on the power measured in the power measurement section; a holding section for holding at least one of the average powers; a plurality of correlation sections which correspond to the plurality of antennas on a one-to-one basis, each of the correlation sections determining a correlation value between a signal received through a corresponding antenna and amplified by the gain amplifier and a predetermined pattern; a correlation detector for detecting the predetermined pattern in a signal received through each of the plurality of antennas based on a correlation value determined by a corresponding one of the correlation sections and an average power corresponding to the antenna and outputting a detection result; and a gain controller for generating the gain control signal such that the gain amplifier operates with a fixed gain till the control section determines an antenna that is to be subsequently selected and thereafter operates with a gain determined according to an average power corresponding to the selected antenna, wherein the control section determines an antenna through which a signal including the predetermined pattern detected by the correlation detector is received as the antenna that is to be subsequently selected based on the detection result of the correlation detector and outputs the antenna selection signal to select the determined antenna.

With the above features, the plurality of correlation sections, which correspond to the plurality of antennas on a one-by-one basis, each detect the predetermined pattern. Therefore, it cannot happen that detection of the predetermined pattern is performed on the mixture of signals received through the plurality of antennas irrespective of the timing of arrived wireless packets. Thus, the detection accuracy of the predetermined pattern improves, and the antenna that is to be subsequently selected can be quickly determined.

Preferably, in the aforementioned diversity receiver, when the predetermined pattern is detected in any of the signals received through the plurality of antennas, the control section selects the larger one of an average power held by the holding section and an average power of the signal in which the predetermined pattern is detected and determines an antenna corresponding to the selected average power as the antenna that is to be subsequently selected.

Preferably, the aforementioned diversity receiver further comprises a correlation holding section. The correlation detector determines, for each of the plurality of antennas, a difference between a correlation value determined by a corresponding one of the plurality of correlation sections and an average power corresponding to the antenna. The correlation holding section holds the difference output from the correlation detector and outputs the difference to the control section. The control section determines the antenna that is to be subsequently selected based on the differences between the correlation value and the average power which are output from the correlation detector and the correlation holding section.

With the above features, the correlation holding section holds the difference between the correlation value and the average power. Therefore, an antenna having the maximum difference between the correlation value and the average power is determined as the antenna that is to be subsequently selected, and as a result, a signal which is least affected by channel distortion can be received.

Preferably, the correlation detector holds a calculated latest average power and determines a difference between the held average power and a correlation value determined by one of the plurality of correlation sections which corresponds to an antenna corresponding to the held average power.

Preferably, when correlation with the predetermined pattern is detected in a plurality of signals among those received by the plurality of antennas, the control section selects the larger one of the difference between the correlation value and the average power which is held by the correlation holding section and the differences between the correlation value and the average power of the signals in which the correlation is detected and determines an antenna corresponding to the selected difference between the correlation value and the average power as the antenna that is to be subsequently selected.

Preferably, in the aforementioned diversity receiver, each of the plurality of correlation sections includes a selector, and a shift register for sequentially shifting an input signal and storing the shifted signal. When an antenna corresponding to the correlation section is selected, the selector selects the amplified signal output from the gain amplifier and outputs the selected signal to the shift register, but when otherwise, the selector selects the shifted value and outputs the selected value to the shift register.

Preferably, in the aforementioned diversity receiver, the control section generates, for each antenna, a correlation process notice signal indicative of a period during which a correlation process is to be performed on a signal received through the antenna. The averaging section calculates an average power when the correlation process notice signal is effective.

Preferably, in the aforementioned diversity receiver, the control section sets a total sum of a period for stabilizing a received power and a period for calculating an average power to be equal to an interval for the sequential selection among a plurality of antennas.

Preferably, the aforementioned diversity receiver further comprises a register f6r storing the period for stabilizing a received power and the period for calculating an average power.

Preferably, the aforementioned diversity receiver further comprises: an automatic frequency controller for performing an automatic frequency control process on the amplified signal output from the gain amplifier; and a demodulation section for performing a demodulation process on the frequency-controlled signal output from the automatic frequency controller.

Preferably, the demodulation section detects an error in data transmitted by a received signal and notifies the control section about the error. When an error is detected by the demodulation section, the control section determines an antenna other than a currently-selected antenna as the antenna that is to be subsequently selected.

Preferably, when an average power of a signal received through a selected antenna is smaller than a predetermined value, the control section keeps the gain control signal unchanged.

Preferably, when an average power of a signal received through a selected antenna is smaller than a predetermined value, the control section determines the antenna that is to be subsequently selected and compels the automatic frequency controller to start an automatic frequency control process without changing the gain control signal.

Preferably, the control section generates, for each antenna, a correlation process notice signal indicative of a period during which a correlation process is to be performed on a signal received through the antenna. If none of the correlation process notice signals for antennas other than the antenna that is to be subsequently selected is effective, the control section compels the automatic frequency controller to start an automatic frequency control process.

Preferably, the control section generates, for each antenna, a correlation process notice signal indicative of a period during which a correlation process is to be performed on a signal received through the antenna. The correlation detector holds a calculated latest average power every time the correlation process notice signal becomes effective.

According to another aspect of the present invention, there is provided a diversity reception method, comprising: the step of generating an antenna selection signal such that a plurality of antennas are sequentially selected on a one-by-one basis; an amplification step of amplifying, based on a gain control signal, a signal which is received through an antenna selected according to the antenna selection signal; a power measurement step of measuring a power of the signal amplified at the amplification step; an averaging step of calculating an average power of each of signals received through the plurality of antennas based on the power measured at the power measurement step; a holding step of holding at least one of the average powers; a correlation step of determining a correlation value between each of signals received through the plurality of antennas and amplified at the amplification step and a predetermined pattern; a correlation detection step of detecting the predetermined pattern in a signal received through each of the plurality of antennas based on a determined correlation value and an average power corresponding to the antenna; a gain control step of generating the gain control signal such that the amplification step is carried out with a fixed gain till an antenna that is to be subsequently selected is determined and thereafter carried out with a gain determined according to an average power of a signal received through the selected antenna; and the step of determining an antenna through which a signal including the predetermined pattern detected at the correlation detection step is received as the antenna that is to be subsequently selected and generating the antenna selection signal to select the determined antenna.

Preferably, in the aforementioned diversity reception method, the correlation detection step includes determining, for each of the plurality of antennas, a difference between a determined correlation value and an average power corresponding to the antenna. The diversity reception method further comprises a correlation holding step of holding the difference determined at the correlation detection step, and the step of determining the antenna that is to be subsequently selected based on the difference between the correlation value and the average power which is determined at the correlation detection step and the difference between the correlation value and the average power which is held at the correlation holing step.

According to the present invention, an optimum antenna can be selected within a short period of time. Since an optimum antenna can be selected for every one of arriving packets, stable communication can be realized even when the transmission environment abruptly changes or even when packets are transmitted from a plurality of terminals.

### BRIEF DESCRIPTION OF THE DRAWINGS

FIG. 1 is a block diagram of a diversity receiver according to embodiment 1 of the present invention.

FIG. 2 shows an example of a structure of a packet received by the diversity receiver of FIG. 1.

FIG. 3 is a timing chart showing signals in respective sections of the diversity receiver of FIG. 1.

FIG. 4 is a block diagram showing a structure of a first correlation section of FIG. 1.

FIG. 5 is a block diagram showing a structure of a correlation detector of FIG. 1.

FIG. 6 is a block diagram of a diversity receiver which includes only one correlation section.

FIG. 7 is a timing chart showing signals in respective sections of the diversity receiver of FIG. 6.

FIG. 8 is a timing chart showing signals in respective sections of the diversity receiver of FIG. 1 where an antenna switching interval is longer than the length of pattern P.

FIG. 9 is a graph showing noise produced at the time of antenna switching.

FIG. 10 shows another example of a structure of a packet received by the diversity receiver of FIG. 1.

FIG. 11 is a block diagram showing an example of a structure of a demodulation section of FIG. 1.

FIG. 12 is a timing chart illustrating an automatic frequency control operation of the diversity receiver of FIG. 1 at the time of a weak electric field.

FIG. 13 is a block diagram of a diversity receiver according to embodiment 2 of the present invention.

FIG. 14 is a block diagram showing a structure of a correlation detector of FIG. 13.

FIG. 15 is a timing chart showing signals in respective sections of the diversity receiver of FIG. 13.

FIG. 16A is a graph which shows the correlation value where a received signal is not affected by channel distortion. FIG. 16B is a graph which shows the correlation value where a received signal is affected by channel distortion.

FIG. 17 is a block diagram of a conventional antenna diversity receiver.

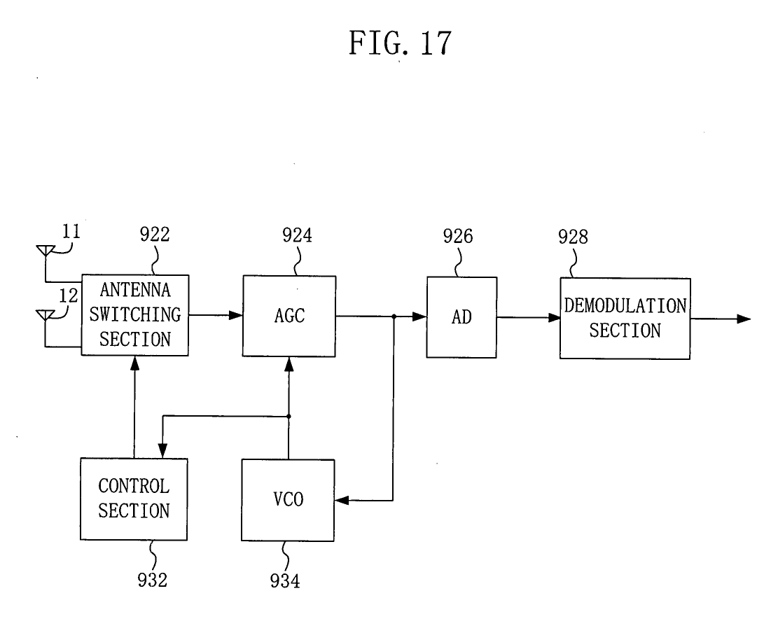

### DESCRIPTION OF THE PREFERRED EMBODIMENTS

Hereinafter, embodiments of the present invention will be described with reference to the drawings.

### Embodiment 1

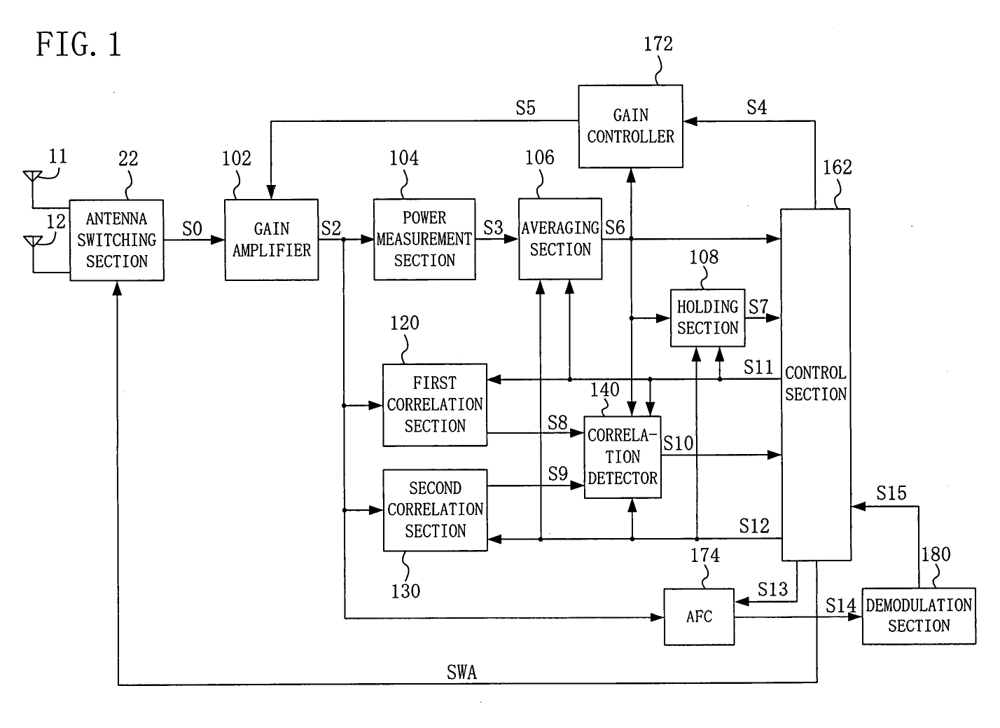

FIG. 1 is a block diagram of a diversity receiver according to embodiment 1 of the present invention. The diversity receiver of FIG. 1 includes a gain amplifier 102, a power measurement section 104, an averaging section 106, a holding section 108, a first correlation section 120, a second correlation section 130, a correlation detector 140, a control section 162, a gain controller 172, an automatic frequency controller (AFC) 174, and a demodulation section 180. The diversity receiver of FIG. 1 selects any one of a first antenna 11 and a second antenna 12. More specifically, antenna selection signal SWA is generated for an antenna switching section 22 to select any one of signals received through the antennas 11 and 12.

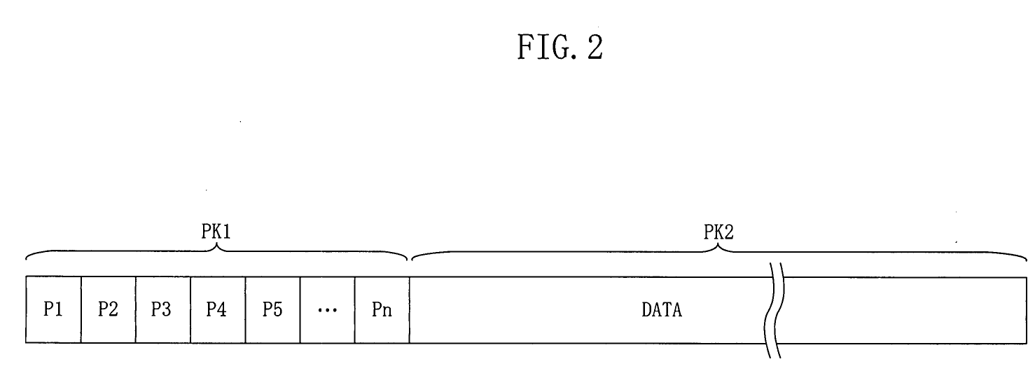

FIG. 2 shows an example of a structure of a packet received by the diversity receiver of FIG. 1. The packet of FIG. 2 includes preamble part PK1 and data part PK2. Preamble part PK1 includes patterns P1, P2, . . . Pn (n≧2). Each of patterns P1, P2, . . . Pn (n≧2) is predetermined pattern P. That is, predetermined pattern P is repeated at least twice in preamble part PK1. Although any pattern can be used as pattern P, a PN (Pseudo Noise) sequence, a chirp waveform, or the like, which has a high autocorrelation characteristic, is preferably used. Data part PK2 includes data which is to be transmitted.

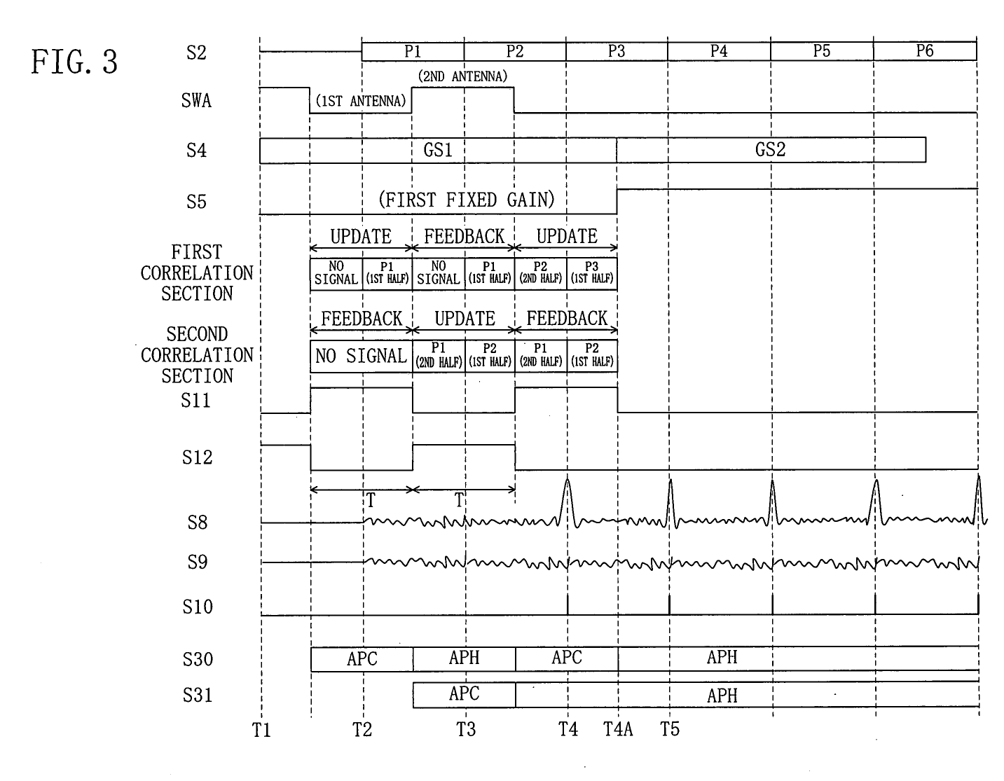

FIG. 3 is a timing chart showing signals in respective sections of the diversity receiver of FIG. 1. Herein, it is assumed that the signal received through the antenna 11 is less affected by channel distortion than the signal received through the antenna 12 is. In FIG. 3, the intervals between time T1, time T2, time T3, time T4, time T5, . . . are each referred to as “time period T”. The times which occur T/2 after time T2, time T3, and time T4 are referred to as “time T2A”, “time T3A”, and “time T4A”, respectively.

An operation of the receiver which is on standby for signal reception where no signal is input, for example, is now described. The control section 162 outputs antenna selection signal SWA to the antenna switching section 22 and outputs gain switching signal S4 to the gain controller 172. The antenna switching section 22 selects a signal received through the antenna 11 or the antenna 12 according to antenna selection signal SWA and outputs the selected signal as signal SO to the gain amplifier 102. If antenna selection signal SWA is at a low potential (“L”), the antenna switching section 22 selects a signal received through the antenna 11. If antenna selection signal SWA is at a high potential (“H”), the antenna switching section 22 selects a signal received through the antenna 12.

When the receiver is on standby for signal reception (“standby period”), the control section 162 alternately changes the level of antenna selection signal SWA between “H” and “L” such that the antenna 11 and the antenna 12 are alternately selected. Therefore, the antenna switching section 22 alternately selects the antenna 11 and the antenna 12 while the receiver is waiting for the arrival of a packet. The control section 162 adjusts the interval of switching the antennas to be at least equal to the length of pattern P. Herein, it is assumed for simplicity of illustration that the antenna switching interval is equal to the length of pattern P (time period T). During the standby period, the control section 162 outputs gain switching signal GS1, which designates the fixed gain, as gain switching signal S4.

The gain controller 172 outputs gain control signal S5, which is indicative of the first fixed gain, to the gain amplifier 102 according to gain switching signal S4. The gain amplifier 102 amplifies received signal S0 input from the antenna switching section 22 by the first fixed gain and outputs the amplified signal as signal S2 to the power measurement section 104, the first correlation section 120, and the second correlation section 130.

The control section 162 outputs first correlation process notice signal S11 to the averaging section 106, the first correlation section 120, and the correlation detector 140. Meanwhile, the control section 162 outputs second correlation process notice signal S12 to the averaging section 106, the second correlation section 130, and the correlation detector 140. First correlation process notice signal S11 and second correlation process notice signal S12 each indicate that its effective period (e.g., “H” period) is a period in which the correlation process is to be performed on signals received through the first and second antennas.

The power measurement section 104 measures the instantaneous power of output signal S2 of the gain amplifier 102 and outputs the measurement result to the averaging section 106. The averaging section 106 averages instantaneous power S3 which is input from the power measurement section 104 only during an effective period of first correlation process notice signal S11 or second correlation process notice signal S12. The averaging section 106 outputs the resultant averaged power to the control section 162, the gain controller 172, the holding section 108, and the correlation detector 140.

The averaging section 106 is alternately supplied with the instantaneous powers of signals received through the antennas 11 and 12 and calculates the average powers for respective one of the signals received through the antennas 11 and 12 to sequentially output the calculated average powers. The holding section 108 holds the average powers of signals already received through antennas other than a currently-selected antenna and outputs the average powers to the control section 162.

The first correlation section 120 and the second correlation section 130 correspond to the antenna 11 and the antenna 12, respectively. The first correlation section 120 determines correlation value S8 between received signal S2 output from the gain amplifier 102 and pattern P and outputs correlation value S8 to the correlation detector 140. The second correlation section 130 determines correlation value S9 between received signal S2 output from the gain amplifier 102 and pattern P and outputs correlation value S9 to the correlation detector 140.

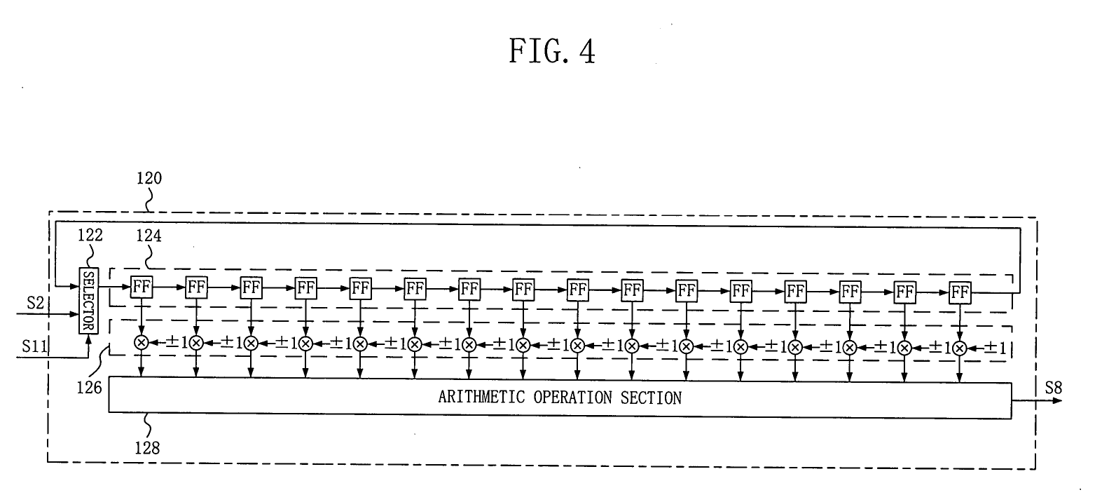

FIG. 4 is a block diagram showing a structure of the first correlation section 120 of FIG. 1. The first correlation section 120 includes a selector 122, a shift register 124 which has 16 serially-connected flip flops (FFs), a multiplication section 126 which has 16 multipliers corresponding to respective bits, and an arithmetic operation section 128.

In FIG. 4, receiving outputs of the selector 122, the shift register 124 sequentially shifts the outputs rightward and stores the shifted outputs. During an effective period of first correlation process notice signal S11, the selector 122 selects received signal S2 output from the gain amplifier 102. During the other period (an ineffective period of first correlation process notice signal S11), the selector 122 selects a shifted value output from a flip flop at the right end.

That is, as shown in FIG. 3, the first correlation section 120 sequentially updates the data of the shift register 124 during an effective period of first correlation process notice signal S11. During an ineffective period of first correlation process notice signal S11, the first correlation section 120 performs a feedback process such that the data of the shift register 124 are sequentially sent back to the input side. The waveform of the pattern held by the shift register 124 can be maintained by this feedback process even if the antenna switching interval is set longer than the length of pattern P. Thus, deterioration in correlation detection accuracy can be prevented.

In the multiplication section 126, a 16-bit value which represents pattern P is set in advance. The multiplication section 126 performs a multiplication for each bit between the value representing pattern P and the 16-bit value held in the shift register 124 and outputs the sum of the multiplication results as correlation value S8.

The structure of the second correlation section 130 is substantially the same as that of the first correlation section 120 except that second correlation process notice signal S12 is input in place of first correlation process notice signal S11, and correlation value S9 is output in place of correlation value S8. Therefore, the descriptions of the second correlation section 130 is herein omitted.

The correlation detector 140 compares correlation value S8 input from the first correlation section 120 and average power value S6 input from the averaging section 106 during an effective period of first correlation process notice signal S11 to detect pattern P included in received signal S2. The correlation detector 140 compares correlation value S9 input from the second correlation section 130 and average power value S6 input from the averaging section 106 during an effective period of second correlation process notice signal S12 to detect pattern P included in received signal S2. The correlation detector 140 calculates a logical sum of these two comparison results and outputs the logical sum as correlation detection value S10 to the control section 162.

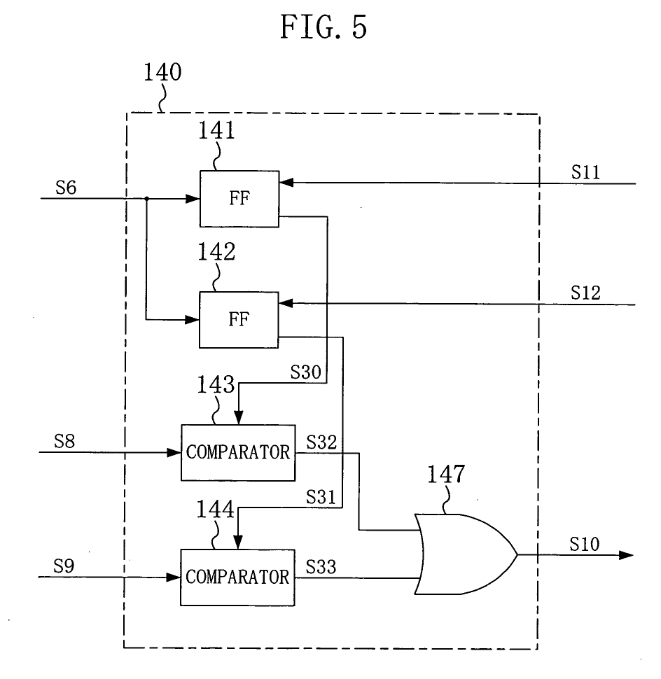

FIG. 5 is a block diagram showing a structure of the correlation detector 140 of FIG. 1. The correlation detector 140 includes flip flops 141 and 142, comparators 143 and 144, and an OR gate 147. As shown in the timing chart of FIG. 3, the flip flops 141 and 142 hold average power value S6 of the latest effective periods of first correlation process notice signal S11 and second correlation process notice signal S12 (average power calculation period APC), respectively, as a latest average power. The flip flops 141 and 142 output the latest average powers as average power values S30 and S31 to the comparators 143 and 144, respectively. Between the current average power calculation period APC and the next average power calculation period APC is average power holding period APH, during which the flip flops 141 and 142 keep holding average power value S6.

The comparator 143 compares average power value S30 and first correlation value S8. If first correlation value S8 is greater than average power value S30, output S32 is “H”. The comparator 144 compares average power value S31 and second correlation value S9. If second correlation value S9 is greater than average power value S31, output S33 is “H”. The OR gate 147 calculates a logical sum of output S32 and output S33 and outputs the logical sum as correlation detection value S10 to the control section 162. Thus, correlation detection value S10 is obtained and output to the control section 162 without mixing the powers of two signals received through the antennas 11 and 12. The “H” level of outputs S32 and S33 and correlation detection value S10 indicate that pattern P has been detected, i.e., a packet has arrived.

In the timing chart of FIG. 3, peaks occur in correlation value S8 because a signal received through the antenna 11 is less affected by channel distortion than a signal received through the antenna 12 is. Correlation detection value S10 has pulses corresponding to the peaks of correlation value S8.

The control section 162 detects the arrival of a packet to determine an antennal that is to be subsequently selected according to average power value S6 of a signal received through a currently-selected antenna, average power value S7 of a signal received through a previously-selected antenna which is held by the holding section 108, or correlation detection value S10 output from the correlation detector 140.

For example, the control section 162 detects a peak in correlation detection value S10 and determines the antenna 11, which is selected at time T4 at which the peak is detected, as the antenna that is to be subsequently selected.

When predetermined pattern P is detected in any of the signals received through the antennas 11 and 12, the control section 162 may select the largest one of the average power at time T3 which is held in the holding section 108 and the average power at time T4 at which a peak is detected in the correlation detection value, and determines the antenna through which the signal of the largest average power is received as the antenna that is to be subsequently selected.

Alternatively, when the average power is equal to or smaller than a predetermined value, the control section 162 may perform the above-described process. When the average power is greater than the predetermined value, the control section 162 may always determine an antenna through which a signal of the maximum average power is received as the antenna that is to be subsequently selected.

After the arrival of a packet has been detected and the antenna that is to be subsequently selected has been determined, the control section 162 outputs antenna selection signal SWA such that the determined antenna is selected and thereafter fixes the level of antenna selection signal SWA (in the example of FIG. 3, signal SWA is fixed at “L” such that the first antenna 11 is kept selected) till the reception of this packet is completed.

After time T4A, the control section 162 outputs second gain switching signal GS2 as gain switching signal S4 to the gain controller 172. The gain controller 172 outputs gain control signal S5 to the gain amplifier 102 for feedback control of the gain such that the average power results in a predetermined value suitable to the automatic frequency controller (AFC) 174 and the demodulation section 180, in other words, such that the gain amplifier 102 performs amplification by the gain determined according to the average power of a signal received through the selected antenna.

The gain-controlled gain amplifier 102 outputs the amplified signal to the demodulation section 180 through the automatic frequency controller 174. The demodulation section 180 demodulates the data part of the packet. After the modulation of the data part has been completed, the control section 162 returns to the signal reception standby state and repeats the above-described operation.

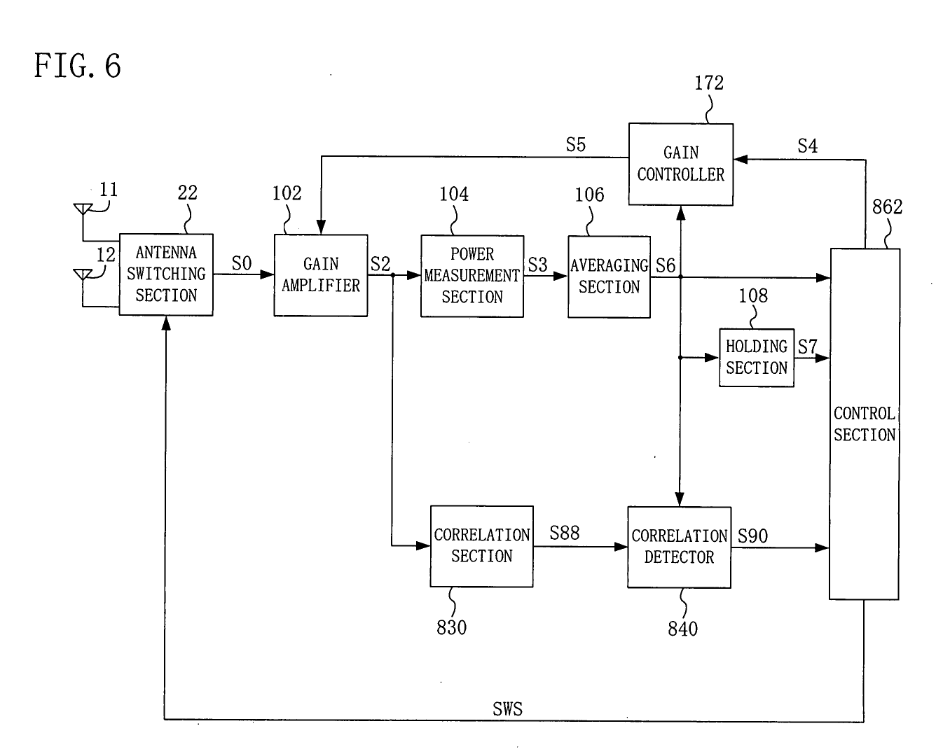

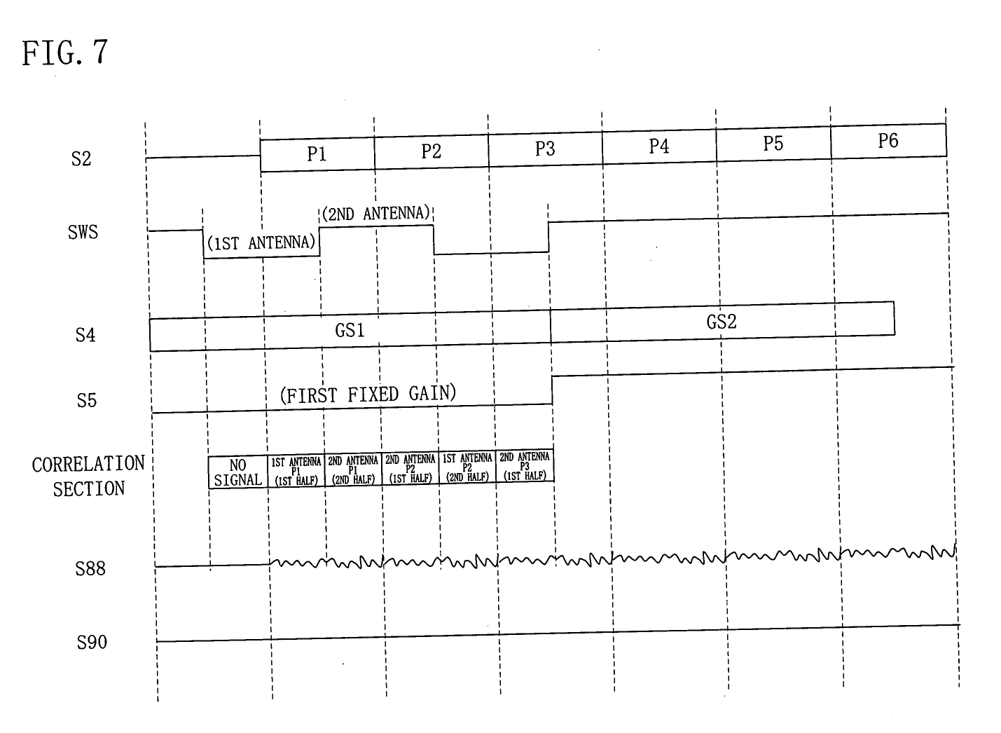

For comparison, a diversity receiver which includes only one correlation section is now described. FIG. 6 is a block diagram of the diversity receiver which includes only one correlation section. FIG. 7 is a timing chart showing signals in respective sections of the diversity receiver of FIG. 6. The diversity receiver of FIG. 6 is substantially the same as the diversity receiver of FIG. 1 except that a correlation section 830, a correlation detector 840 and a control section 862 are provided in place of the first and second correlation sections 120 and 130, the correlation detector 140 and the control section 162.

Since signals received through the antennas 11 and 12 are alternately input to the correlation section 830, a pattern included in a signal received through the antenna 11 and a pattern included in a signal received through the antenna 12 are mixed at the correlation section 830 as illustrated in the timing chart of FIG. 7. Since the signal received through the antenna 11 and the signal received through the antenna 12 have different channel distortions, the correlation detectability decreases when the signals received through the two antennas 11 and 12 are mixed. As a result, the signal reception performance deteriorates.

The diversity receiver of FIG. 1 has a plurality of correlation sections corresponding to a plurality of antennas on a one-to-one basis, and each correlation section can determine a correlation value between a signal received through a corresponding antenna and a predetermined pattern. That is, a correlation can be detected without mixing a pattern included in a signal received through the antenna 11 and a pattern included in a signal received through the antenna 12 irrespective of the timing of inputting the received signal as shown in the timing chart of FIG. 3. Therefore, the correlation detectability increases, and the signal reception performance improves.

The correlation detector 140 includes two flip flops 141 and 142 and two comparators 143 and 144. Thus, the correlation detector 140 can obtain correlation detection value S10 without mixing the powers of two signals received through the antennas 11 and 12.

As described above, in the diversity receiver of FIG. 1, the plurality of correlation sections 120 and 130, which respectively correspond to the plurality of antennas 11 and 12, detect predetermined pattern P. Therefore, it cannot happen that detection of predetermined pattern P is performed on the mixture of signals received through the plurality of antennas 11 and 12 irrespective of the timing of arrived wireless packets. Thus, the detection accuracy of the predetermined pattern improves, and the antenna that is to be subsequently selected can be quickly determined.

The antenna that is to be subsequently selected can be quickly determined even when the high frequency sections (e.g., the antenna switching section 22 and the gain amplifier 102) are formed by inexpensive elements which would cause a large process delay. Thus, the automatic frequency control (AFC) process and the demodulation process can be carried out without spending a long time in the antenna selection process, and the signal reception performance can be further improved.

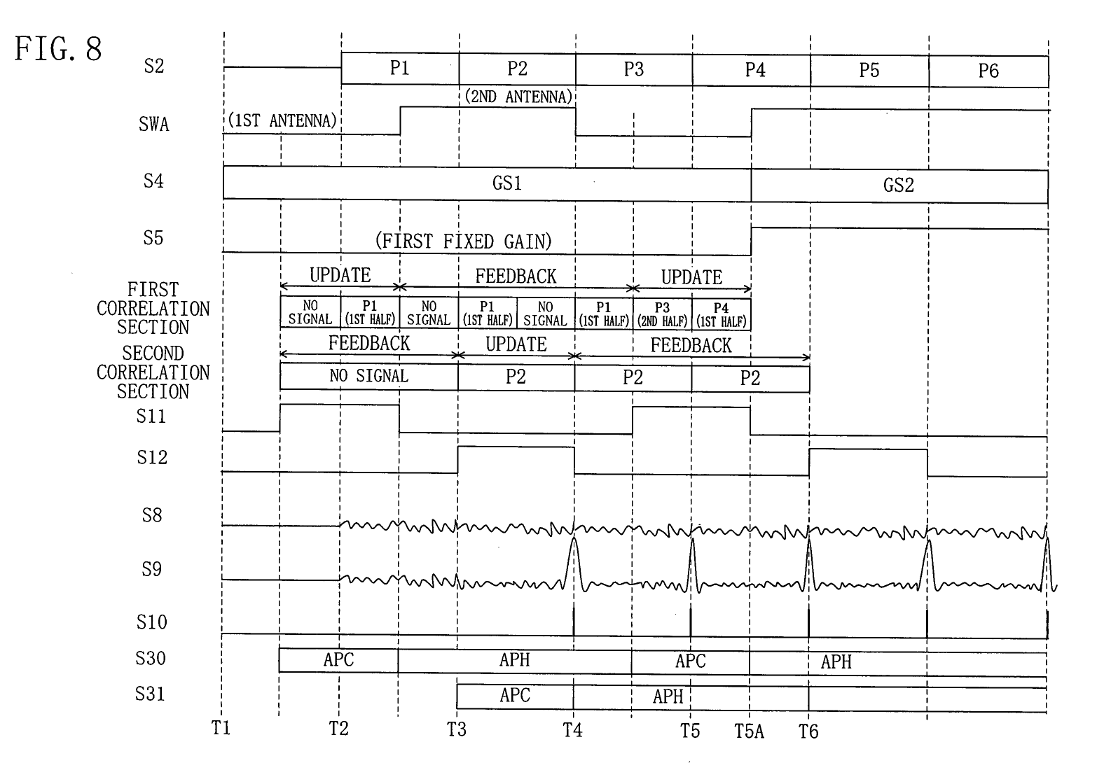

In the above descriptions, for simplicity, the antenna switching interval is equal to the length of pattern P. However, the antennas may be switched with an interval longer than the length of pattern P. FIG. 8 is a timing chart showing signals in respective sections of the diversity receiver of FIG. 1 where the antenna switching interval is longer than the length of pattern P. In FIG. 8, the antenna switching interval is 1.5 T.

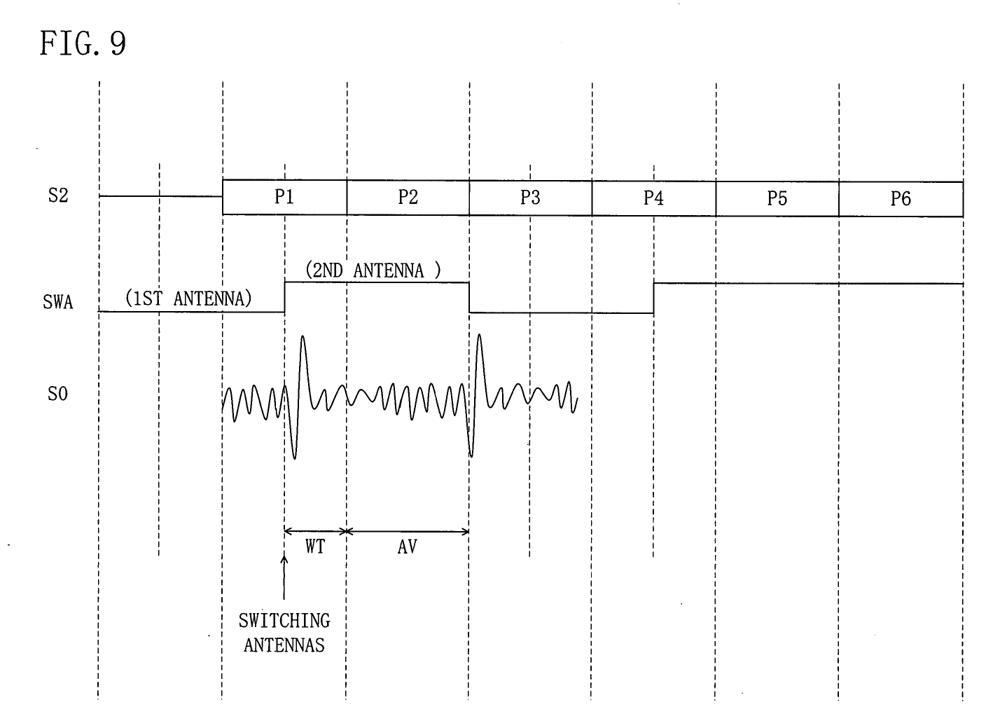

FIG. 9 is a graph which illustrates noise produced at the time of switching antennas. As shown in FIG. 9, noise can be produced at the moment of switching antennas due to the antenna switching section 22 or other reasons. Thus, after the switching of antennas, period WT, which lasts till the received power becomes stable, may be provided. In this case, the averaging section 106 calculates the average power in power averaging period AV which follows. period WT. That is, the sum of power stabilization period WT and power averaging period AV is equal to the interval of the sequential selection among the antennas 11 and 12. With this, more accurate power measurement can be realized.

Although not shown, the diversity receiver of FIG. 1 may further include registers for storing values which designate the lengths of power stabilization period WT and power averaging period AV. In this case, the control section 162 reads the values of these registers to set power stabilization period WT and power averaging period AV.

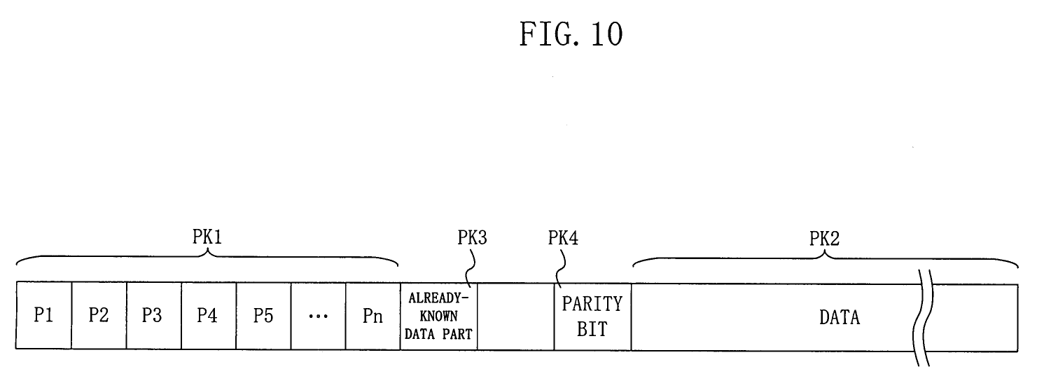

FIG. 10 shows another example of a structure of a packet received by the diversity receiver of FIG. 1. The packet of FIG. 10 includes already-known data part PK3 and parity bit part PK4 between preamble part PK1 and data part PK2 of the packet of FIG. 2. Already-known data part PK3 is data having a predetermined content. Parity bit part PK4 is the parity of already-known data part PK3. This parity may be any of even parity and odd parity. When a packet as shown in FIG. 10 is transmitted, on the receiver side, error evaluation is performed after demodulation such that selection of antennas can be carried out.

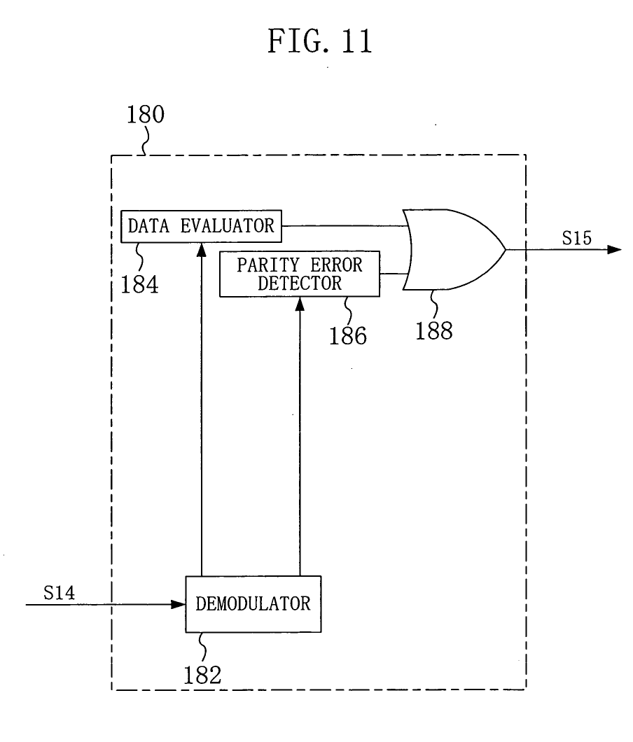

FIG. 11 is a block diagram showing an example of a structure of the demodulation section 180 of FIG. 1. The demodulation section 180 includes a demodulator 182, a data evaluator 184, a parity error detector 186, and an OR gate 188.

The demodulator 182 demodulates signal S14 output from the automatic frequency controller 174 to output the demodulated signal to the data evaluator 184 and the parity error detector 186. The data evaluator 184 compares the demodulated already-known data part PK3 and the data which is supposed to be transmitted as already-known data part PK3. If there is an error, the data evaluator 184 outputs a signal of “H” to the OR gate 188. The parity error detector 186 compares a parity bit demodulated by the demodulator 182 and a bit which is supposed to be transmitted as parity bit part PK4. When there is a parity error, the parity error detector 186 outputs a signal of “H” to the OR gate 188.

When the already-known data or parity includes an error, the OR gate 188 outputs a signal of “H” as error signal S15 to notify the control section 162 about the error. In this case, the control section 162 determines an antenna other than the currently-selected antenna as the antenna that is to be subsequently selected. Hence, using an undesirable antenna which would be erroneously selected because of a correlation peak produced by interference, for example, can be avoided.

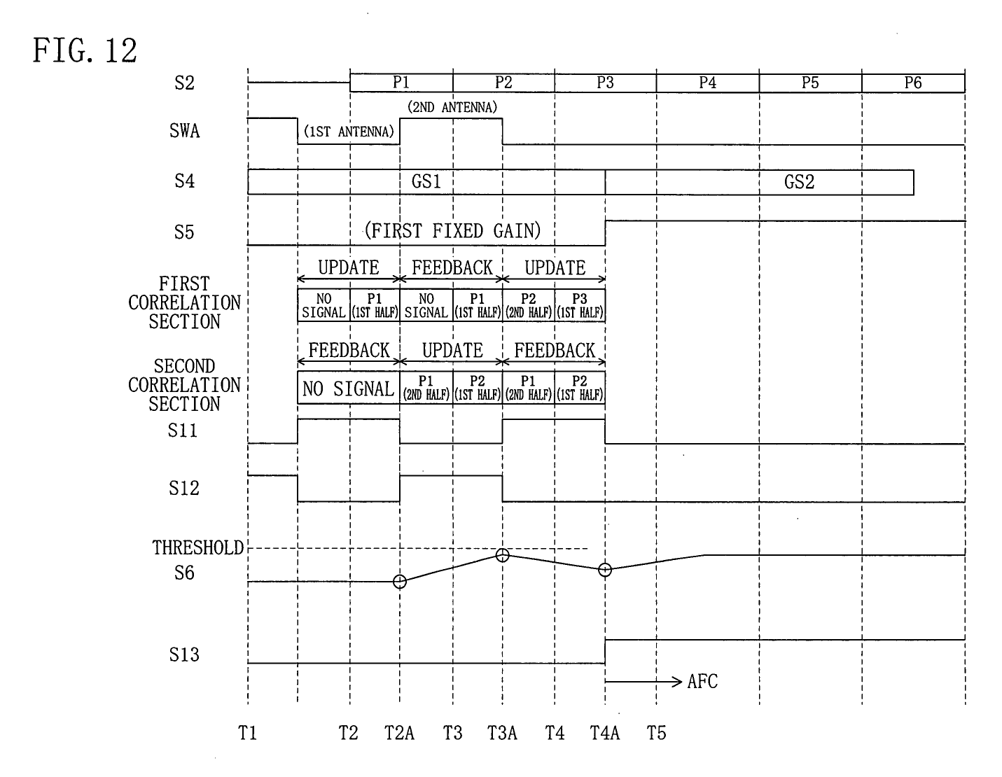

FIG. 12 is a timing chart illustrating an automatic frequency control operation of the diversity receiver of FIG. 1 at the time of a weak electric field. Normally, during the standby period, gain control signal S5 represents a large fixed gain (first fixed gain) by which a received weak signal can be amplified. Reception of a weak signal where the threshold is set to a value approximate to an average power of such a weak signal is explained in the following paragraphs.

After the selection of an antenna, the gain controller 172 performs feedback control of the gain according to gain switching signal S4 such that an average power of a signal received through the selected antenna reaches a predetermined value which is suitable for data demodulation, while average power value S6 scarcely varies. Therefore, if average power value S6 is lower than the threshold as shown in FIG. 12, the control section 162 keeps gain control signal S5 unchanged. Further, in this case, immediately after the antenna selection, the control section 162 makes automatic frequency control (AFC) start notice signal S13 effective, thereby compelling the automatic frequency controller 174 to start the AFC process without changing the gain by changing gain control signal S5.

With a longer period for the AFC process, the accuracy of AFC increases, and the signal reception performance for a weak signal can be further improved. Considering a process delay in an actual circuit, there is a possibility that a correlation process notice signal for an antenna other than the selected antenna is effective after the antenna selection. In such a case, AFC start notice signal S13 may be made effective at the time when a correlation process start notice signal for an antenna other than the selected antenna is made ineffective.

### Embodiment 2

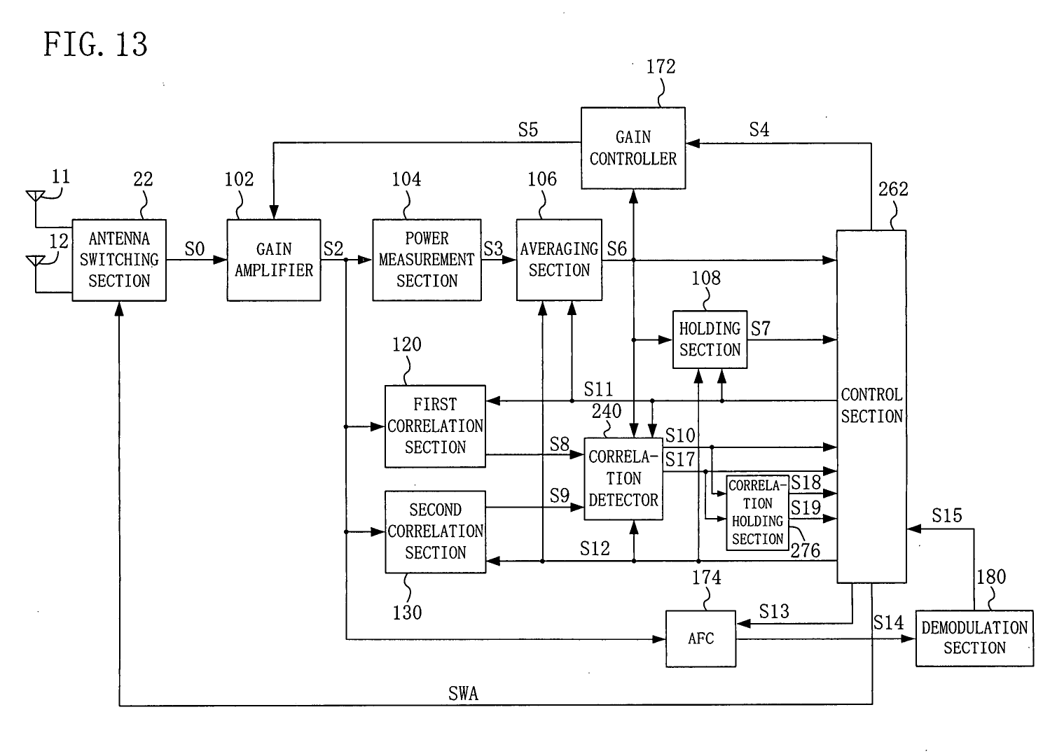

FIG. 13 is a block diagram of a diversity receiver according to embodiment 2 of the present invention. The diversity receiver of FIG. 13 includes a correlation detector 240 and a control section 262 in substitution for the correlation detector 140 and the control section 162 of the diversity receiver of FIG. 1 and further includes a correlation holding section 276. The other elements are the same as those illustrated with reference to FIG. 1 and hence denoted by the same reference numerals, and therefore, the detailed descriptions thereof are herein omitted.

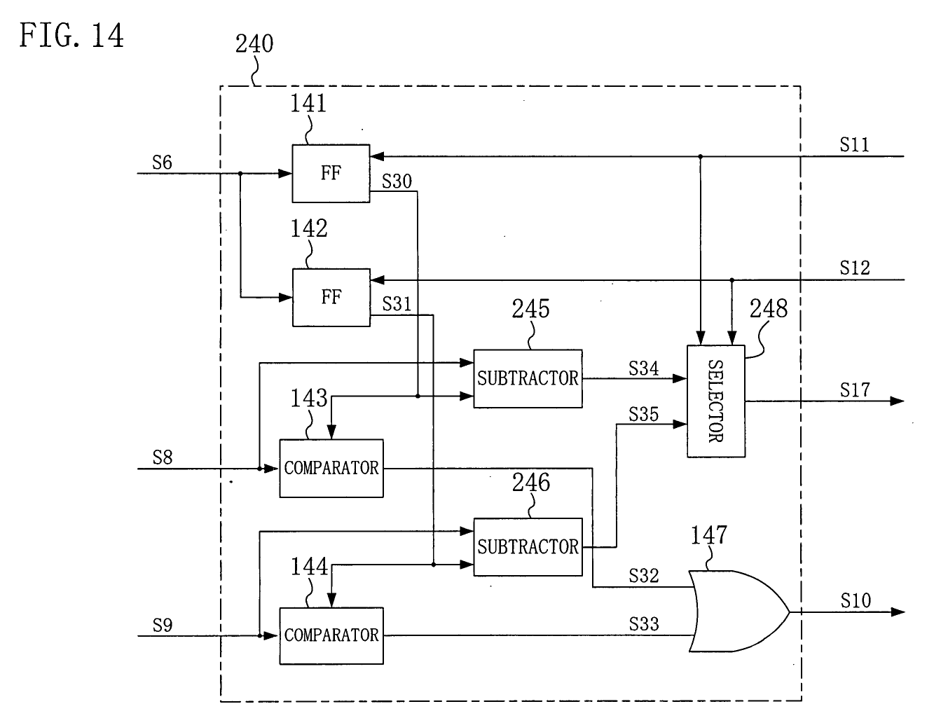

FIG. 14 is a block diagram showing a structure of the correlation detector 240 of FIG. 13. The correlation detector 240 includes subtractors 245 and 246 and a selector 248 in addition to the components of the correlation detector 140 of FIG. 5.

In an effective period of first correlation process notice signal S11, the subtractor 245 subtracts average power value S30 from first correlation value S8 and outputs resultant subtraction result S34 to the selector 248. In an effective period of second correlation process notice signal S12, the subtractor 246 subtracts average power value S31 from second correlation value S9 and outputs resultant subtraction result S35 to the selector 248. During an effective period of first correlation process notice signal S1l, the selector 248 selects subtraction result S34. During an effective period of second correlation process notice signal S12, the selector 248 selects subtraction result S35. The selector 248 outputs the selected value as difference S17 between the correlation value and the average power to the control section 262 and the correlation holding section 276.

The correlation holding section 276 holds correlation detection value S10 and difference S17 between the correlation value and the average power, which have been determined based on a signal previously received through an antenna other than the currently-selected antenna, and outputs these values to the control section 262 as correlation detection value S18 and difference S19 between the correlation value and the average power, respectively.

The control section 262 detects the arrival of a packet based on any of the following 6 values in order to select an antenna which is to be used for signal reception. Specifically, the control section 262 detects the arrival of a packet based on any of average power value S6, correlation detection value S10, and difference S17 between the correlation value and the average power, which have been determined based on a signal received through a currently-selected antenna, and average power value S7, correlation detection value S18, and difference S19 between the correlation value and the average power, which have been determined based on a signal received through a previously-selected antenna.

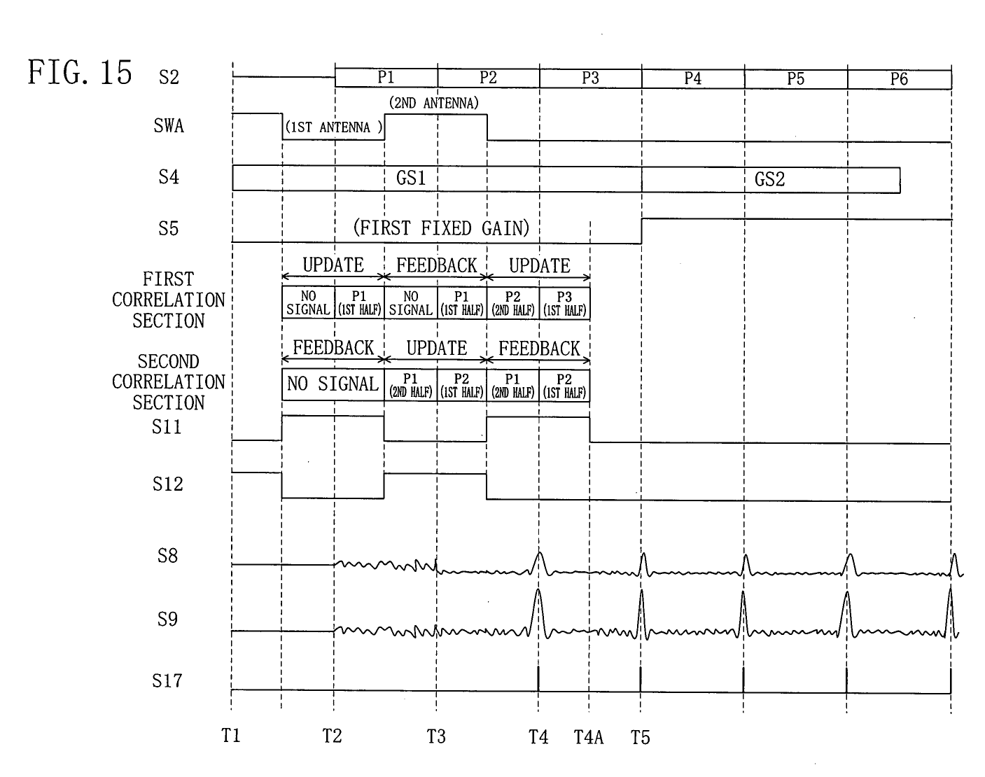

FIG. 15 is a timing chart showing signals in respective sections of the diversity receiver of FIG. 13. Herein, it is assumed that the signal received through the antenna 12 is less affected by channel distortion than the signal received through the antenna 11 is.

An operation of the receiver which is on standby for signal reception where no signal is input, for example, is now described. When no signal is input, the control section 262 alternately changes the level of antenna selection signal SWA with predetermined intervals. The antenna switching interval may be equal to or longer than the length of pattern P. Herein, it is assumed for simplicity of illustration that the antenna switching interval is equal to the length of pattern P. This assumption is the same as that made for the diversity receiver of FIG. 1.

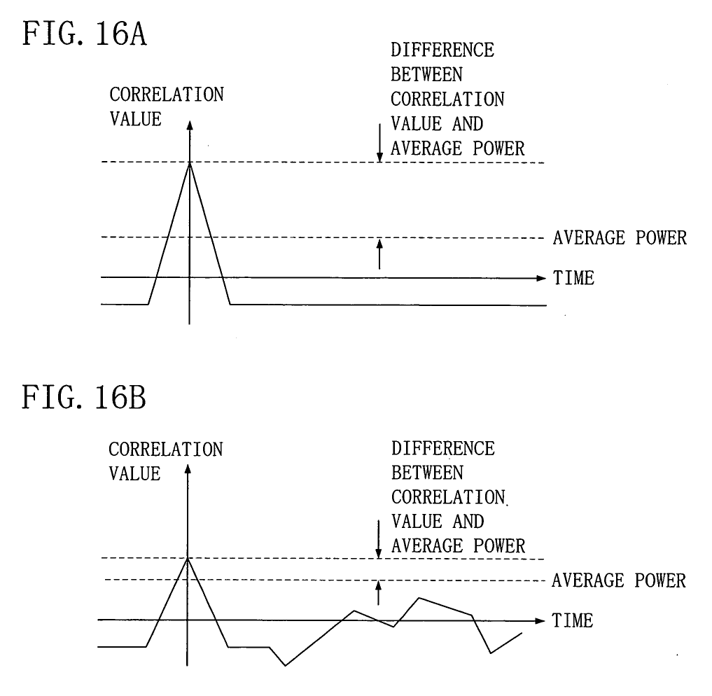

FIG. 16A is a graph which shows the correlation value where a received signal is not affected by channel distortion. FIG. 16B is a graph which shows the correlation value where a received signal is affected by channel distortion. As shown in FIGS. 16A and 16B, as a received signal is more affected by channel distortion, the difference between a peak of the correlation value and the average power decreases.

If one of correlation detection value S10 and correlation detection value S18 indicates that correlation has been detected, the control section 262 selects an antenna through which a signal used for calculation of the correlation detection value indicative of the detection of correlation is received. If both correlation detection value S10 and correlation detection value S18 indicate that correlation has been detected, the control section 262 selects the larger one of difference S17 between the correlation value and the average power which is output from the correlation detector240 and difference S19 between the correlation value and the average power which is output from the correlation holding section 276. Then, the control section 262 determines an antenna through which a signal used for the calculation has been received as the antenna that is to be subsequently selected. In the example of FIG. 15, the control section 262 selects the antenna 12 which corresponds to difference S19 between the correlation value and the average power as the antenna that is to be subsequently selected and outputs antenna selection signal SWA which is indicative of the antenna 12.

Alternatively, when the average power is equal to or smaller than a predetermined value, the control section 262 may perform the above-described process. When the average power is greater than the predetermined value, the control section 262 may always select an antenna through which a signal of the maximum average power is received.

As described above, in the diversity receiver of FIG. 13, the correlation detector 240 determines a difference between a correlation value (correlation value between a received signal and predetermined pattern P) and an average power, and the correlation holding section 276 holds this difference. Therefore, an antenna with which the difference between the correlation value and the average power is maximum can be determined as the antenna that is to be subsequently selected. As a result, a signal which is least affected by the channel distortion can be received, and the signal reception performance can be increased.

In embodiment 1, the diversity receiver of FIG. 13 may be used in substitution for the diversity receiver of FIG. 1.

Although in the above-described examples there are provided two reception antennas, a larger number of antennas may be provided. In this case, the diversity receiver includes correlation sections corresponding to the antennas on a one-to-one basis, and the average power is measured for each antenna, based on which the antenna that is to be subsequently selected is determined.

As described above, the present invention enables selection of the optimum antenna within a short period of time and is therefore useful for high speed wireless packet communication devices, and the like.

What is claimed is:

1. A diversity receiver, comprising:
a control section for generating an antenna selection signal such that a plurality of antennas are sequentially selected on a one-by-one basis;
a gain amplifier for amplifying, based on a gain control signal, a signal which is received through an antenna selected according to the antenna selection signal;
a power measurement section for measuring a power of the signal amplified by the gain amplifier;
an averaging section for calculating an average power of each of signals received through the plurality of antennas based on the power measured in the power measurement section;
a holding section for holding at least one of the average powers;
a plurality of correlation sections which correspond to the plurality of antennas on a one-to-one basis, each of the correlation sections determining a correlation value between a signal received through a corresponding antenna and amplified by the gain amplifier and a predetermined pattern;
a correlation detector for detecting the predetermined pattern in a signal received through each of the plurality of antennas based on a correlation value determined by a corresponding one of the correlation sections and an average power corresponding to the antenna and outputting a detection result; and
a gain controller for generating the gain control signal such that the gain amplifier operates with a fixed gain till the control section determines an antenna that is to be subsequently selected and thereafter operates with a gain determined according to an average power corresponding to the selected antenna,
wherein the control section determines an antenna through which a signal including the predetermined pattern detected by the correlation detector is received as the antenna that is to be subsequently selected based on the detection result of the correlation detector and outputs the antenna selection signal to select the determined antenna.

2. The diversity receiver of claim 1, wherein when the predetermined pattern is detected in any of the signals received through the plurality of antennas, the control section selects the larger one of an average power held by the holding section and an average power of the signal in which the predetermined pattern is detected and determines an antenna corresponding to the selected average power as the antenna that is to be subsequently selected.

3. The diversity receiver of claim 1, further comprising a correlation holding section, wherein:
the correlation detector determines, for each of the plurality of antennas, a difference between a correlation value determined by a corresponding one of the plurality of correlation sections and an average power corresponding to the antenna;
the correlation holding section holds the difference output from the correlation detector and outputs the difference to the control section; and
the control section determines the antenna that is to be subsequently selected based on the differences between the correlation value and the average power which are output from the correlation detector and the correlation holding section.

4. The diversity receiver of claim 3, wherein the correlation detector holds a calculated latest average power and determines a difference between the held average power and a correlation value determined by one of the plurality of correlation sections which corresponds to an antenna corresponding to the held average power.

5. The diversity receiver of claim 3, wherein when correlation with the predetermined pattern is detected in a plurality of signals among those received by the plurality of antennas, the control section selects the larger one of the difference between the correlation value and the average power which is held by the correlation holding section and the differences between the correlation value and the average power of the signals in which the correlation is detected and determines an antenna corresponding to the selected difference between the correlation value and the average power as the antenna that is to be subsequently selected.

6. The diversity receiver of claim 1, wherein:
each of the plurality of correlation sections includes
a selector, and
a shift register for sequentially shifting an input signal and storing the shifted signal;
when an antenna corresponding to the correlation section is selected, the selector selects the amplified signal output from the gain amplifier and outputs the selected signal to the shift register, but when otherwise, the selector selects the shifted value and outputs the selected value to the shift register.

7. The diversity receiver of claim 1, wherein:
the control section generates, for each antenna, a correlation process notice signal indicative of a period during which a correlation process is to be performed on a signal received through the antenna; and
the averaging section calculates an average power when the correlation process notice signal is effective.

8. The diversity receiver of claim 1, wherein the control section sets a total sum of a period for stabilizing a received power and a period for calculating an average power to be equal to an interval for the sequential selection among a plurality of antennas.

9. The diversity receiver of claim 8, further comprising a register for storing the period for stabilizing a received power and the period for calculating an average power.

10. The diversity receiver of claim 1, further comprising:
an automatic frequency controller for performing an automatic frequency control process on the amplified signal output from the gain amplifier; and
a demodulation section for performing a demodulation process on the frequency-controlled signal output from the automatic frequency controller.

11. The diversity receiver of claim 10, wherein:
the demodulation section detects an error in data transmitted by a received signal and notifies the control section about the error; and
when an error is detected by the demodulation section, the control section determines an antenna other than a currently-selected antenna as the antenna that is to be subsequently selected.

12. The diversity receiver of claim 10, wherein when an average power of a signal received through a selected antenna is smaller than a predetermined value, the control section keeps the gain control signal unchanged.

13. The diversity receiver of claim 10, wherein when an average power of a signal received through a selected antenna is smaller than a predetermined value, the control section determines the antenna that is to be subsequently selected and compels the automatic frequency controller to start an automatic frequency control process without changing the gain control signal.

14. The diversity receiver of claim 13, wherein:
the control section generates, for each antenna, a correlation process notice signal indicative of a period during which a correlation process is to be performed on a signal received through the antenna, and
if none of the correlation process notice signals for antennas other than the antenna that is to be subsequently selected is effective, the control section compels the automatic frequency controller to start an automatic frequency control process.

15. The diversity receiver of claim 10, wherein:
the control section generates, for each antenna, a correlation process notice signal indicative of a period during which a correlation process is to be performed on a signal received through the antenna, and
the correlation detector holds a calculated latest average power every time the correlation process notice signal becomes effective.

16. A diversity reception method, comprising:
the step of generating an antenna selection signal such that a plurality of antennas are sequentially selected on a one-by-one basis;
an amplification step of amplifying, based on a gain control signal, a signal which is received through an antenna selected according to the antenna selection signal;
a power measurement step of measuring a power of the signal amplified at the amplification step;
an averaging step of calculating an average power of each of signals received through the plurality of antennas based on the power measured at the power measurement step;
a holding step of holding at least one of the average powers;
a correlation step of determining a correlation value between each of signals received through the plurality of antennas and amplified at the amplification step and a predetermined pattern;
a correlation detection step of detecting the predetermined pattern in a signal received through each of the plurality of antennas based on a determined correlation value and an average power corresponding to the antenna;
a gain control step of generating the gain control signal such that the amplification step is carried out with a fixed gain till an antenna that is to be subsequently selected is determined and thereafter carried out with a gain determined according to an average power of a signal received through the selected antenna; and
the step of determining an antenna through which a signal including the predetermined pattern detected at the correlation detection step is received as the antenna that is to be subsequently selected and generating the antenna selection signal to select the determined antenna.

17. The diversity reception method of claim 16, wherein:
the correlation detection step includes determining, for each of the plurality of antennas, a difference between a determined correlation value and an average power corresponding to the antenna; and
the method further comprises
a correlation holding step of holding the difference determined at the correlation detection step, and
the step of determining the antenna that is to be subsequently selected based on the difference between the correlation value and the average power which is determined at the correlation detection step and the difference between the correlation value and the average power which is held at the correlation holing step.
